(19) United States
(12) Patent Application Publication
(10) Pub. No.: US 2012/0167577 A1
(43) Pub. Date: Jul. 5, 2012

(54) GAS TURBINE SYSTEM AND PROCESS

(75) Inventors: Bhaskar PEMMI, Bangalore (IN); Anil Kumar SHARMA, Bangalore (IN); Rajarshi SAHA, Bangalore (IN); Indrajit MAZUMDER, Bangalore (IN)

(73) Assignee: GENERAL ELECTRIC COMPANY, Schenectady, NY (US)

(21) Appl. No.: 12/983,408

(22) Filed: Jan. 3, 2011

(51) Int. Cl. F02C 3/20

(52) U.S. Cl. 60/772; 60/722

(57) ABSTRACT

A gas turbine system and process include a compressor component configured to compress fluid to form a compressed fluid stream, a combustor configured to receive at least a first portion of the compressed fluid stream and at least partially combust a syngas to form a combustor discharge stream, and a turbine component positioned to receive the combustor discharge stream and to form a turbine component stream. In the system and process, a cool stream directed from a second system cools the turbine component stream.

### FIELD OF THE INVENTION

The present disclosure is directed to gas turbine systems and processes. More specifically, the present disclosure is directed to systems and methods using CO₂ for cooling turbine components.

### BACKGROUND OF THE INVENTION

In power generation systems, operational efficiencies are desired for meeting increased energy demand at lower costs. Carbon sequestration in power systems captures carbon dioxide from exhaust gases and stores it in the sequestration process. Capturing the carbon consumes substantial amounts of energy and reduces performance efficiency of known power systems.

In a known power generation system, a closed-loop cooling arrangement within a gas turbine is cooled with a non-electrically conductive liquid. A pump circulates the liquid and heat transfer is enhanced by an orifice placed within the loop that reduces pressure. The known system suffers from the drawback of not being able to provide carbon capture with desirable efficiency.

In another known power generation system, an open-loop cooling arrangement including nitrogen from an air separation unit is used. The system suffers from the drawback that it is only applicable for oxygen-based (gasifier) systems in integrated gasification combined cycle (IGCC) operations.

A gas turbine system and process that is more efficient and does not suffer from the drawbacks of the prior art would be desirable in the art.

### BRIEF DESCRIPTION OF THE INVENTION

In one embodiment, a gas turbine system includes a compressor component configured to compress fluid to form a compressed fluid stream, a combustor configured to receive at least a first portion of the compressed fluid stream and at least partially combust a syngas to form a combustor discharge stream, and a turbine component positioned to receive the combustor discharge stream and to form a turbine component stream. At least a second portion of the compressed fluid stream is directed to the turbine component stream. A cool CO₂ stream directed from a CO₂ capture system cools the turbine component stream. The cool CO₂ stream is heated by the turbine component stream to form at least a heated CO₂ stream. At least a portion of the heated CO₂ stream transfers heat to the compressed fluid stream from the compressor to the combustor.

In one embodiment, a gas turbine system includes a compressor component configured to compress fluid to form a compressed fluid stream, a combustor configured to receive at least a first portion of the compressed fluid stream and at least partially combust a syngas to form a combustor discharge stream, and a turbine component positioned to receive the combustor discharge stream and to form a turbine component stream. At least a second portion of the compressed fluid stream is directed to the turbine component stream. A cool nitrogen stream directed from a second system cools the turbine component stream. The cool nitrogen stream is heated by the turbine component stream to form at least a heated nitrogen stream. At least a portion of the heated nitrogen stream transfers heat to the compressed fluid stream from the compressor to the combustor.

In one embodiment, a process includes providing a CO₂ capture system comprising an absorber and a stripper for forming a cool CO₂ stream, directing the cool CO₂ stream to a turbine component, transferring heat from a turbine component stream in the turbine component to the cool CO₂ stream to form at least a heated CO₂ stream, and directing at least a portion of the heated CO₂ stream through a heat exchanger to the CO₂ capture system.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 schematically shows an exemplary gas turbine system according to an embodiment of the disclosure.

FIG. 2 schematically shows an exemplary CO₂ capture system with a simplified depiction of an exemplary gas turbine system according to an embodiment of the disclosure.

FIG. 3 schematically shows an exemplary gas turbine system according to an embodiment of the disclosure.

Wherever possible, the same reference numbers will be used throughout the drawings to represent the same parts.

### DETAILED DESCRIPTION OF THE INVENTION

Provided is a gas turbine system and method that is more efficient and does not suffer from the drawbacks of the prior art. Embodiments of the present disclosure permit the disclosed systems and methods to be applied to simple and combined cycle IGCC operations, permit the disclosed systems and methods to incorporate CO₂ capture processes into IGCC operations, permit the disclosed systems and methods to incorporate other systems into IGCC operations, permit increased efficiency by decreasing the amount of fuel required for reaching a predetermined firing temperature, permit increased efficiency by increasing an exhaust temperature being directed to a heat recovery steam generator, and permit lower cost installation, operation, and maintenance.

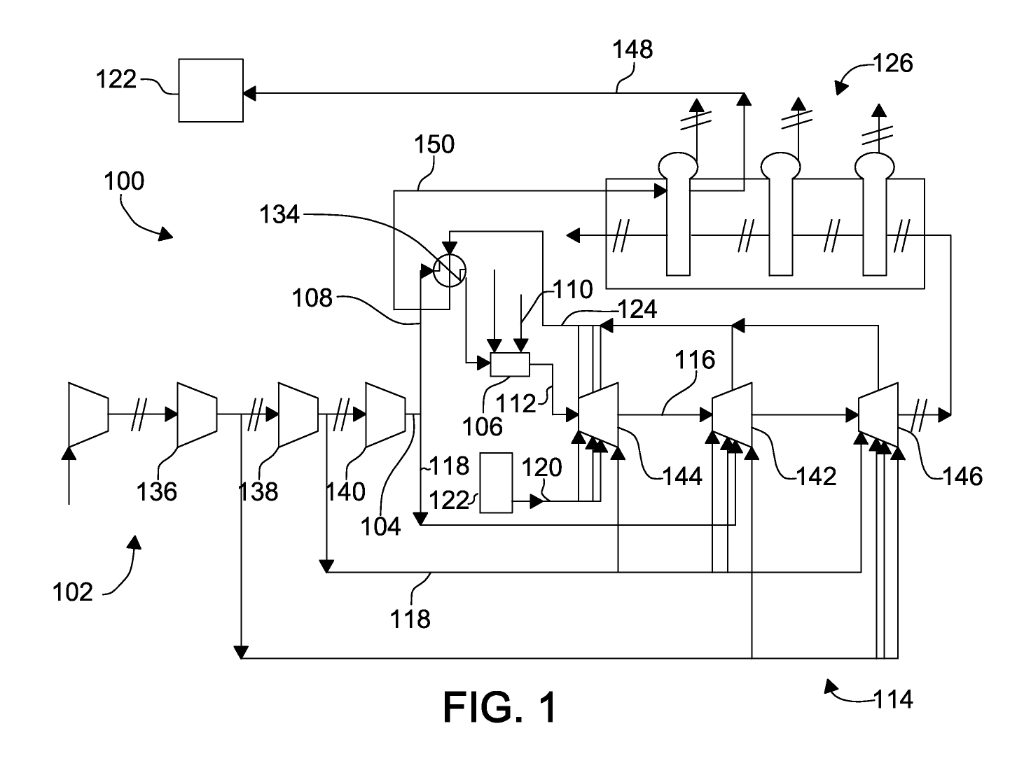

FIG. 1 shows an exemplary gas turbine system 100. The system 100 includes a compressor component 102, a combustor 106, and a turbine component 114. The compressor component 102 is configured to compress fluid (for example, air or another atmospheric gas) to form a compressed fluid stream 104. The combustor 106 is configured to receive at least a first portion 108 of the compressed fluid stream 104 and at least partially combust a syngas 110 to form a combustor discharge stream 112. The turbine component 114 is positioned to receive the combustor discharge stream 112 to form a turbine component stream 116. A second portion 118 of the compressed fluid stream 104 is directed to cool the turbine component stream 116.

A cool CO₂ stream 120 directed from a CO₂ capture system 122 cools the turbine component stream 116. The cool CO₂ stream 120 has a temperature of about 300° F. to about 600° F. or about 100° F. to about 400° F. lower in temperature than gas turbine compressor discharge air. In one embodiment, the cool CO₂ stream 120 consists essentially of gaseous CO₂. In another embodiment, the cool CO₂ stream 120 includes CO₂ at a concentration greater than that of air. The cool CO₂ stream 120 is heated by the turbine component stream 116 to form at least a heated CO₂ stream 124 (for example, having a temperature above about 1000° F.). A portion or all of the heated CO₂ stream 124 transfers heat to the compressed fluid stream 108. In one embodiment, the cool CO₂ stream 120 is directed to the turbine component stream 116 without assistance of a pump.

In one embodiment, the gas turbine system 100 includes a heat exchanger 134. The heat exchanger 134 is positioned to transfer heat from the heated CO₂ stream 124 to the first portion 108 of the compressed CO₂ stream 104.

As will be appreciated, multiple stages of the compressor component 102 and the turbine component 114 permit any suitable portions of the compressed fluid stream 104 and/or the cool CO₂ stream 120 to exchange heat with the turbine component stream 116 and/or the combustion discharge stream 112 at a plurality of pressure and/or temperature relationships. Any suitable number of stages may be included. For example, in one embodiment, eighteen compressor stages are included. In a further embodiment, the first compressor stage 136 is the ninth stage, the second compressor stage 138 is the thirteenth stage, and the third compressor stage 140 is the eighteenth stage. One or more portions of the compressed fluid stream 104 may be directed from multiple compressor stages to the turbine component 114 thereby cooling the turbine component stream 116. In one embodiment, the third compressor stage 140 directs the second portion 118 of the compressed fluid stream 104 to a second turbine stage 142 in the turbine component 114.

The turbine component 114 includes a first turbine stage 144 and a second turbine stage 142. In one embodiment, the turbine component 114 further includes a third turbine stage 146. Any suitable number of turbine stages may be included. One or more turbine stages of the turbine component 114 is positioned to receive the combustor discharge stream 112 to form the turbine component stream 116. The second portion 118 of the compressed fluid stream 104 directed to the turbine component 114 cools the turbine component stream 116. In one embodiment, the second compressor stage 138 directs the second portion 118 of the compressed fluid stream 104 to the first turbine stage 144, the second turbine stage 142, the third turbine stage 146, or combinations thereof.

The turbine component stream 116 is further cooled by the cool CO₂ stream 120 in the first turbine stage 144. In one embodiment, the cool CO₂ stream 120 is directed to the first turbine stage 144, heat is transferred from the turbine component stream 116 in the first turbine stage 144 to the cool CO₂ stream 120 to form at least the heated CO₂ stream 124, and at least a portion of the heated CO₂ stream 124 is directed through the heat exchanger 134 to the CO₂ capture system 122. In a further embodiment, the turbine component 114 is arranged and disposed to receive the combustion discharge stream 112 from the combustor 106 and the heat exchanger 134 is arranged and disposed to transfer heat from the heated CO₂ stream 124 to at least the portion 108 of the compressed fluid stream 104 directed to the combustor 106.

In another embodiment, CO₂ is used for closed loop cooling of the turbine component 114. In this embodiment, a closed loop CO₂ stream includes the heated CO₂ stream 124 and the cool CO₂ stream 120. For example, the combustion discharge stream 112 is directed to the turbine component 114 to form the turbine component stream 116, the turbine component stream 116 is cooled with a cooled portion 120 of a closed loop CO₂ stream thereby forming the heated portion 124 of the closed loop CO₂ stream, and the compressed fluid stream 104 is heated by the heated portion 124 of the closed loop CO₂ stream. In a further embodiment, a portion of the cooled portion 120 of the closed loop CO₂ stream is directed from the carbon capture system 122 and at least a portion of the heated portion 124 of the closed loop CO₂ stream is directed to the carbon capture system 122.

In one embodiment, the gas turbine system 100 further includes a heat recovery steam generator 126. In this embodiment, the turbine component stream 116 is directed to the heat recovery steam generator 126. In one embodiment, a portion 150 or all of the heated CO₂ stream 120 is directed to the heat recovery steam generator 126. A portion of an outlet stream 148 from the heat recovery steam generator 126 is directed to the CO₂ capture system 122 for CO₂ capture/sequestration.

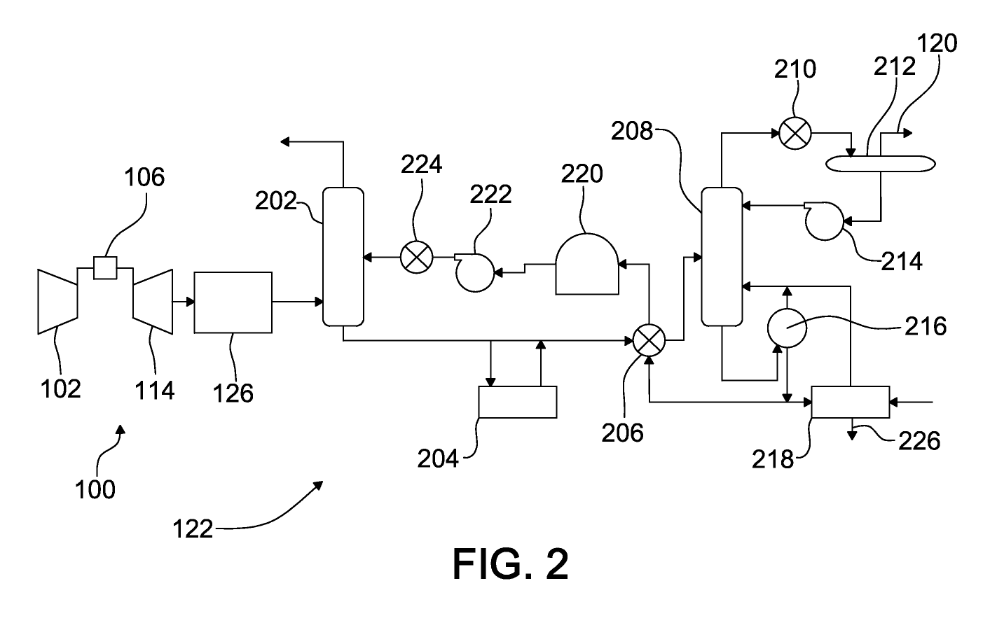

FIG. 2 shows a schematic view of an exemplary CO₂ capture system 122 with a simplified depiction of the gas turbine system 100. The CO₂ capture system 122 can be any suitable CO₂ capture system. In one embodiment, the CO₂ capture system 122 is a chemical absorption process. For example, in one embodiment, the CO₂ capture system 122 includes an absorber 202 for receiving flue gas from heat recovery steam generator 126. The flue gas is filtered by a filtration device 204, transfers heat through a heat exchanger 206 (for example, a cross heat exchanger), and travels into a stripper 208. The stripper 208 separates CO₂ from other components of the flue gas (for example, NOₓ and SO_{X}). From the stripper 208, a portion of the flue gas containing CO₂ is condensed by a condenser 210 and directed to a reflux drum 212 as captured CO₂. The captured CO₂ 120 is in general directed to a separate multistage intercooled-compressor system (not shown) for sequestration. A portion of the captured CO₂ 120 may be redirected to the stripper 208 by a reflux pump 214. Other portions of the flue gas in the stripper 208 are directed to a reboiler 216 for separation and either processed by a reclaimer 218 to form a sludge 226 or directed through the heat exchanger 206, a storage tank 220, a booster pump 222, and a lean amine cooler 224 prior to reentering the absorber 202 and being vented to a stack (not shown).

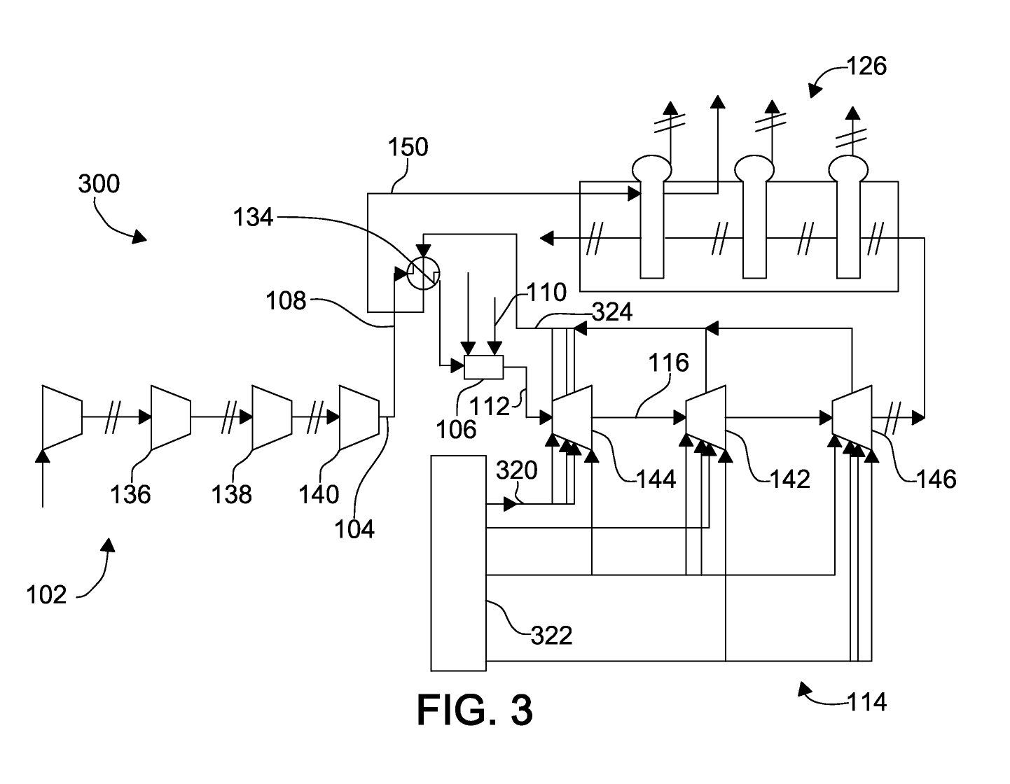

FIG. 3 shows another exemplary gas turbine system 300. The system 300 includes the compressor component 102, the combustor 106, and the turbine component 114. The compressor component 102 is configured to compress fluid (for example, air or another atmospheric gas) to form the compressed fluid stream 104. The combustor 106 is configured to receive at least the first portion 108 of the compressed fluid stream 104 and at least partially combust the syngas 110 to form the combustor discharge stream 112. The turbine component 114 is positioned to receive the combustor discharge stream 112 to form the turbine component stream 116. The second portion 118 of the compressed fluid stream 104 is directed to cool the turbine component stream 116.

A cool nitrogen stream 320 directed from an air separation unit 322 or other suitable process cools the turbine component stream 116. The cool nitrogen stream 320 is heated by the turbine component stream 116 to form at least a heated nitrogen stream 324 (for example, having a temperature above about 1000° F.). A portion or all of the heated nitrogen stream 324 transfers heat to the compressed fluid stream 108.

In one embodiment, the gas turbine system 100 includes a heat exchanger 134. The heat exchanger 134 is positioned to transfer heat from the heated nitrogen stream 324 to the first portion 108 of the compressed fluid stream 104.

As will be appreciated, multiple stages of the compressor component 102 and the turbine component 114 permit any suitable portions of the compressed fluid stream 104 and/or the cool nitrogen stream 320 to exchange heat with the turbine component stream 116 and/or the combustion discharge stream 112 at a plurality of pressure and/or temperature relationships.

The turbine component stream 116 is further cooled by the cool nitrogen stream 320 in the first turbine stage 144. In one embodiment, the cool nitrogen stream 320 is directed to the first turbine stage 144, heat is transferred from the turbine component stream 116 in the first turbine stage 144 to the cool nitrogen stream 320 to form at least the heated nitrogen stream 324, and at least a portion of the heated nitrogen stream 324 is directed through the heat exchanger 134 to the heat recovery steam generator 126. In a further embodiment, the first turbine stage 144 is arranged and disposed to receive the combustion discharge stream 112 from the combustor 106 and the heat exchanger 134 is arranged and disposed to transfer heat from the heated nitrogen stream 324 to at least the portion 108 of the compressed fluid stream 104 directed to the combustor 106.

While only certain features and embodiments of the invention have been shown and described, many modifications and changes may occur to those skilled in the art (for example, variations in sizes, dimensions, structures, shapes and proportions of the various elements, values of parameters (for example, temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A gas turbine system, comprising:
a compressor component configured to compress fluid to form a compressed fluid stream;
a combustor configured to receive at least a first portion of the compressed fluid stream and at least partially combust a syngas to form a combustor discharge stream; and
a turbine component positioned to receive the combustor discharge stream and to form a turbine component stream;
wherein at least a second portion of the compressed fluid stream is directed to the turbine component stream, a cool CO₂ stream directed from a CO₂ capture system cools the turbine component stream, the cool CO₂ stream is heated by the turbine component stream to form at least a heated CO₂ stream, and at least a portion of the heated CO₂ stream transfers heat to the compressed fluid stream directed from the compressor to the combustor.

2. The gas turbine system of claim 1, further comprising a heat recovery steam generator, wherein the turbine component stream is directed to the heat recovery steam generator.

3. The gas turbine system of claim 2, wherein at least a second portion of the heated CO₂ stream is directed to the heat recovery steam generator.

4. The gas turbine system of claim 3, wherein at least a portion of an outlet stream from the heat recovery steam generator is directed to the CO₂ capture system.

5. The gas turbine system of claim 1, further comprising a heat exchanger, the heat exchanger positioned to transfer heat from the heated CO₂ stream to the first portion of the compressed air stream.

6. The gas turbine system of claim 1, further comprising the CO₂ capture system.

7. The gas turbine system of claim 1, wherein the compressor component comprises eighteen compressor stages.

8. The gas turbine system of claim 7, wherein an eighteenth compressor stage directs the second portion of the compressed fluid stream to a second turbine stage of the turbine component.

9. The gas turbine system of claim 7, wherein a ninth compressor stage and a thirteenth compressor stage direct the second portion of the compressed fluid stream to a first turbine stage of the turbine component, a second turbine stage of the turbine component, and a third turbine stage of the turbine component.

10. The gas turbine system of claim 1, wherein the turbine component comprises a first turbine stage and a second turbine stage.

11. The gas turbine system of claim 10, wherein the turbine component further comprises a third turbine stage.

12. The gas turbine system of claim 11, wherein the turbine component stream is cooled by the cool CO₂ stream for the second turbine stage and the third turbine stage.

13. The gas turbine system of claim 11, wherein the compressor component comprises a first compressor stage, a second compressor stage, and a third compressor stage.

14. The gas turbine system of claim 1, wherein the CO₂ capture system comprises an absorber and a stripper for forming the cool CO₂ stream.

15. A gas turbine system, comprising:
a compressor component configured to compress fluid to form a compressed fluid stream;
a combustor configured to receive at least a first portion of the compressed fluid stream and at least partially combust a syngas to form a combustor discharge stream; and
a turbine component positioned to receive the combustor discharge stream and to form a turbine component stream;
wherein at least a second portion of the compressed fluid stream is directed to the turbine component stream, a cool nitrogen stream directed from a second system cools the turbine component stream, the cool nitrogen stream is heated by the turbine component stream to form at least a heated nitrogen stream, and at least a portion of the heated nitrogen stream transfers heat to the compressed fluid stream from the compressor to the combustor.

16. The gas turbine system of claim 15, wherein the second system is an air separation unit.

17. The gas turbine system of claim 15, further comprising a heat recovery steam generator, wherein the turbine component stream is directed to the heat recovery steam generator.

18. The gas turbine system of claim 17, wherein at least a second portion of the heated nitrogen stream is directed to the heat recovery steam generator.

19. A process, comprising:
providing a CO₂ capture system, the CO₂ capture system comprising an absorber and a stripper for forming a cool CO₂ stream;
directing the cool CO₂ stream to a turbine component;
transferring heat from a turbine component stream in the turbine component to the cool CO₂ stream to form at least a heated CO₂ stream; and
directing at least a portion of the heated CO₂ stream through a heat exchanger to the CO₂ capture system.

20. The process of claim 19, wherein the turbine component is arranged and disposed to receive a combustion discharge stream from a combustor and the heat exchanger is arranged and disposed to transfer heat from the heated CO₂ stream to at least a portion of a compressed fluid stream directed to the combustor.
